(19) United States
(12) Patent Application Publication
(10) Pub. No.: US 2022/0337426 A1
(43) Pub. Date: Oct. 20, 2022

(54) DIGITAL KEY DEVICE AND METHOD FOR ACTIVATING DIGITAL KEY SERVICE

(71) Applicant: InfoKeyVault Technology Co., Ltd., Taipei City (TW)

(72) Inventors: CHIA-HSIN CHENG, Taipei City (TW); CHIH-PING HSIAO, Taipei City (TW); MING-TING WU, Taipei City (TW)

(21) Appl. No.: 17/722,424

(22) Filed: Apr. 18, 2022

(30) Foreign Application Priority Data
Apr. 19, 2021 (TW) 110113909

(51) Int. Cl. H04L 9/32

(52) U.S. Cl. CPC H04L 9/3247; H04L 9/3226

(57) ABSTRACT

A digital key service device includes a casing, an input device, a data storage unit and a controlling unit. The input device is disposed near the casing or mounted on the casing, and configured to receive a user operation input. The data storage unit is disposed in the casing, and configured to store digital data and a digital key. The controlling unit is disposed in the casing, and configured to use the digital key to perform a digital key service or output the digital data to a host when authentication is complete. The authentication includes an operation verification procedure for verifying the user operation input. The authentication is complete when the controlling unit determines that the user operation input conforms to a preset timing-based input set.

### FIELD OF THE INVENTION

The present disclosure relates to a digital key device and a method for activating a digital key service provided by the digital key device, particularly to a digital key device applied to a user information device and a method for activating a digital key service provided by the digital key device.

### BACKGROUND OF THE INVENTION

With the development of information technology, more and more secret or private data (e.g. accounts and passwords) are generated, but are stored along with non-confidential data in a user information device such as personal computer, notebook or smartphone without reliable security mechanism particularly for the secret and private data. In recent years, a smartphone or other similar portable information device is frequently used to be communicated with another information device or a server over the cloud through various data transmission channels, e.g. USB interface, Bluetooth or wireless network for data interchange or financial transaction. These secret or private data are probably stolen due to insufficient information security mechanism and thus causes unfavorable damages. For example, a hacker may hack into the user information device and input a correct personal identification number (PIN) to log in the user information device successfully. Therefore, the hacker can arbitrarily access and exploit the important data stored in the user information device. It is desired to improve the data security of the existing user information device to provide enhanced data protection.

### SUMMARY OF THE INVENTION

An aspect of the present disclosure provides a digital key device adapted to be in communication with a host. The digital key device includes a casing, an input device, a data storage unit and a controlling unit. The input device is disposed near the casing or mounted on the casing and configured to receive a first user operation input. The data storage unit and the controlling unit are disposed in the casing. The data storage unit is configured to store digital data and a digital key. The controlling unit is in communication with the host, the input device and the data storage unit. The controlling unit uses the digital key stored in the data storage unit to perform a digital key service or outputs the digital data stored in the data storage unit to the host when authentication is complete. The authentication includes a first operation verification procedure for verifying the first user operation input, and the authentication is complete when the controlling unit determines that the first user operation input conforms to a first preset timing-based input set.

In an embodiment, the first user operation input is a gesture operation input and the input device is a touch button, a physical button or a touch pad exposed from the casing. The input device receives one or more user touch or pressing actions applied to the input device to generate one or more timing-based input events in response to the one or more user touch or pressing actions. Alternatively, the input device is a vibration sensor disposed in the casing. The vibration sensor senses vibration or touch made on the casing held by the user to generate the one or more timing-based input events in response to the vibration or touch made on the casing.

In an embodiment, the first user operation input is an audio operation input and the input device is a microphone disposed on the casing. The microphone senses a sound made by the user to generate the one or more timing-based input events in response to a rhythm of the sound.

In an embodiment, the one or more timing-based input events are generated according to a specific rhythm of the first user operation input and conform to an encoding format.

In an embodiment, the digital key device includes a prompting device issuing a light signal or a sound signal to prompt the user for input timing of the first user operation input.

In an embodiment, the authentication further includes a personal identification number verification procedure prior to the first operation verification procedure after the digital key device is electrically coupled to the host. The digital key device receives a personal identification number from the host and verifies the received personal identification number.

In an embodiment, the authentication further includes a second operation verification procedure posterior to the first operation verification procedure. The digital key device activates the second operation verification procedure to verify whether a second user operation input conforms to a second preset timing-based input set after completing the first operation verification procedure and receiving a data read command from the host. The controlling unit outputs the digital data to the host in response to the data read command after the authentication is passed.

In an embodiment, the digital key service is using the digital key to encrypt first data received from the host to generate encrypted data with a digital signature. The digital key device activates the second operation verification procedure after completing the first operation verification procedure and receiving a digital signing command from the host. The controlling unit outputs the encrypted data with the digital signature to the host in response to the digital signing command after the authentication is passed.

In an embodiment, the digital key service is using the digital key to encrypt first data or decrypt second data received from the host to generate first encrypted data or second decrypted data. The digital key device activates the second operation verification procedure after completing the first operation verification procedure and receiving a data encrypt command or a data decrypt command from the host. The controlling unit outputs the first encrypted data or the second decrypted data to the host or stores the first encrypted data or the second decrypted data in the data storage unit in response to the data encrypt command or the data decrypt command after the authentication is passed.

In an embodiment, the data storage unit includes a first data storage unit and a second data storage unit. The digital key is stored in the first data storage unit disposed in a secure element, and the digital data are stored in the second data storage unit separate from the secure element.

Another aspect of the present disclosure provides a method for activating a digital key service used with a host and a digital key device which stores therein digital data and a digital key. In the method, a first user operation input is provided to the digital key device. The digital key device automatically activates the digital key service using the digital key stored in the digital key device or automatically outputs the digital data to the host when authentication is complete. The authentication includes a first operation verification procedure for verifying the first user operation input, and the authentication is complete when the digital key device determines that the first user operation input conforms to a first preset timing-based input set.

In an embodiment, the first user operation input is a gesture operation input including one or more touch actions, one or more sliding actions, one or more pressing actions, or one or more shaking actions applied to the digital key device corresponding to one or more timing-based input events.

In an embodiment, the first user operation input is an audio operation input including one or more sound-making actions of the user. The one or more sound-making actions follow a rhythm and are corresponding to one or more timing-based input events.

### BRIEF DESCRIPTION OF THE DRAWINGS

The advantages of the present disclosure will become more readily apparent to those ordinarily skilled in the art after reviewing the following detailed description and accompanying drawings, in which:

FIG. 1 is a block diagram illustrating a digital key device in communication with a host according to an embodiment of the present disclosure;

FIG. 2 is a sequence diagram showing authentication between the digital key device and the host according to an embodiment of the present disclosure;

FIG. 3 is a block diagram illustrating a digital key device in communication with a host according to another embodiment of the present disclosure;

FIG. 4 is a sequence diagram showing a data reading method according to an embodiment of the present disclosure;

FIG. 5 is a sequence diagram showing a data encryption/decryption method according to an embodiment of the present disclosure; and

FIG. 6 is a block diagram illustrating a digital key device in communication with a host according to a further embodiment of the present disclosure.

### DETAILED DESCRIPTION OF PREFERRED EMBODIMENTS

The present disclosure will now be described more specifically with reference to the following embodiments. It is to be noted that the following descriptions of preferred embodiments of this invention are presented herein for purpose of illustration and description only. It is not intended to be exhaustive or to be limited to the precise form disclosed.

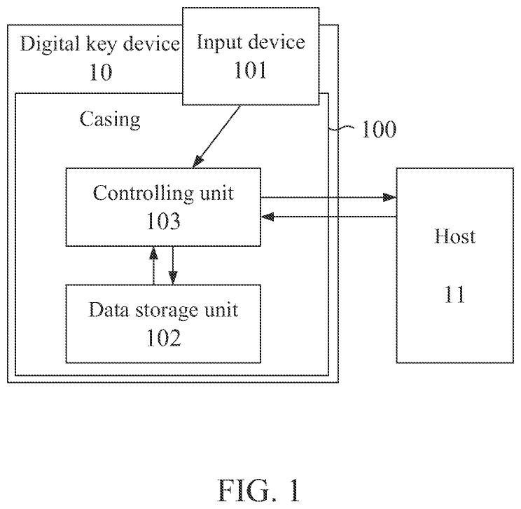

Please refer to FIG. 1, which is a block diagram illustrating a digital key device according to an embodiment of the present disclosure. The digital key device 10 is configured to be in communication with a host 11. The communication type may be based on a wired communication technology (e.g. a Universal Serial Bus (USB) connector electrically coupled to a USB receptacles or a memory interface electrically coupled to a memory card slot) or a wireless communication technology (e.g. Bluetooth connection). The digital key device 10 includes a casing 100, an input device 101, a data storage unit 102 and a controlling unit 103. The data storage unit 102 and the controlling unit 103 are disposed in the casing 100. The data storage unit 102 is configured to store digital data and a digital key. In the embodiment, the input device 101 is mounted on the casing 100 to receive user operation input. The user operation input means on-site operation wherein the user and the digital key device 10 are located in the same space. There is only a short distance between the user and the digital key device 10. The on-site operation made by the user is sensed by the digital key device 10 directly without introducing other signal transmission medium. In an embodiment, the user operation input is a gesture operation provided by the user, referred as user gesture operation input hereinafter. For example, the input device 101 is a touch button, a physical button or a touch pad exposed from the casing 100 for sensing the user touch action, user sliding action or user pressing action applied onto the button. The digital key device 10, in a portable hardware form, could be like a USB device in appearance for being plugged in a computer, or the digital key device 10 could be like a Secure Digital (SD) memory card in appearance for being inserted into a notebook, a tablet computer or a smartphone.

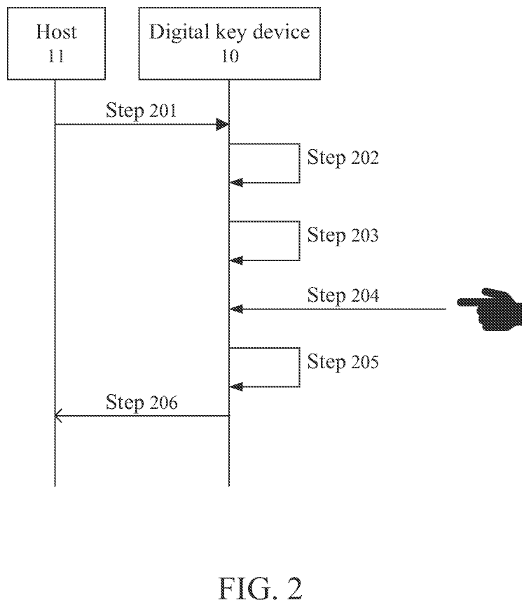

Please refer to FIG. 2, which is a sequence diagram showing authentication between the digital key device 10 and the host 11 according to an embodiment of the present disclosure. At first, the host 11 sends a personal identification number (PIN) to the digital key device 10 electrically coupled to the host 11 (Step 201). Then, the digital key device 10 verifies whether the personal identification number is correct (Step 202). If the personal identification number is verified correct, the digital key device 10 enters a wait mode to wait for user input (Step 203). Once the user provides a user gesture operation input through the input device 101 (Step 204), the digital key device 10 exits the wait mode. The controlling unit 103 performs a first gesture operation verification procedure on the user gesture operation input provided through the input device 101 (Step 205). If the user gesture operation input is verified correct, the digital key device 10 issues an authentication pass message to the host 11 (Step 206). By means of this method, the authentication between the digital key device 10 and the host 11 is carried out efficiently. The double and two-way verification including the personal identification number verification procedure and the gesture operation verification procedure can protect the digital key device 10 from remote hacking.

Thus, even though the host 11 is under remote hacking and controlled to send a correct personal identification number to the digital key device 10, the gesture operation applied on the input device 101 of the digital key device 10 provides further security mechanism. The first gesture operation verification procedure is passed only when the controlling unit 103 judges that the digital key device 10 receives the correct user gesture operation input. The user gesture operation, i.e. on-site operation, can not be made through remote hacking so that malicious access to the digital key device 10 is impeded.

The input device 101 could be a touch button, a touch pad or a physical button mounted on or exposed from the casing 100 of the digital key device 10 to receive a single or a series of touch actions, a single or a series of sliding actions or a single or a series of pressing actions constructing the user gesture operation input. The user gesture operation input is verified correct only when all input event(s) of the user gesture operation input substantially occur in a preset timing and sequence. We say that the user gesture operation input conforms to a preset timing-based input set in this condition. By way of illustration, the user gesture operation input and the timing-based input set includes a plurality of timing-based input events. In an embodiment, the timing-based input events may represent strokes or lines constituting a character, word or pattern, and the user should draw the strokes or lines on a touch pad which is provided for sensing the touch actions. In another embodiment, the timing-based input events may represent a sequence of taps having specific durations (e.g. Morse code or other code with a specific encoding format), and the user should tap on the touch button or click the button in a specific manner. Concretely speaking, for using the Morse code, the user taps the button for dot duration, taps and holds the button for dash duration, and releases the button for space duration. Alternatively, the user could directly draw dashes and dots on the touch pad which can sense the touch actions to provide the timing-based input events in the form of the Morse code. The timing and sequence of the input events in the timing-based input set, representing the pattern, the strokes, the codes or any other sensible physical/gesture operation input or their combination with a specific timing and sequence, could be preset and predefined by the user. In another embodiment, the timing and sequence of the input events in the timing-based input set could be preset by the manufacturer before the sale.

In another embodiment, the input device 101 is implemented by a vibration sensor, e.g. accelerometer or piezoelectric sensor disposed in the casing 100 without exposing from the casing 100. The user gesture operation input may include holding the casing 100 and vibrating it or touching a designated area of the casing 100 directly to provide the timing-based input events. This type of user gesture operation input is also useful to confirm whether the user stays with the digital key device 10 or not.

In a further embodiment, the user operation input is an audio operation input and the input device 101 is a sound receiving device, e.g. a microphone disposed on the casing 100. The user audio operation input may include sound-making actions made by the user with or without tools, e.g. singing, clapping, finger snapping, striking, beating with a stick, and these sound-making actions follow a specific rhythm. Each or several sounds are transformed into a timing-based input event, and theses timing-based input events reflect the rhythm. The user audio operation input is verified correct only when the controlling unit 103 determines that all input events of the user audio operation input substantially occur in a preset timing. In other words, the user audio operation input will be verified when it has the correct rhythm. We say that the user audio operation input conforms to a preset timing-based input set in this condition. The rhythm of the user audio operation input could be obtained by the technique of an automatic Karaoke evaluation system (e.g. Wei-Ho Tsai, Hsin-Chieh Lee, Automatic Evaluation of Karaoke Singing Based on Pitch, Volume, and Rhythm Features, IEEE Transactions on Audio Speech and Language Processing 20(4):1233-1243, May 2012) and the details about this evaluation system are not given herein. The user gesture operation input in Step 204 and the gesture operation verification procedure in Step 205 could be replaced with the user audio operation input and the corresponding audio operation verification procedure.

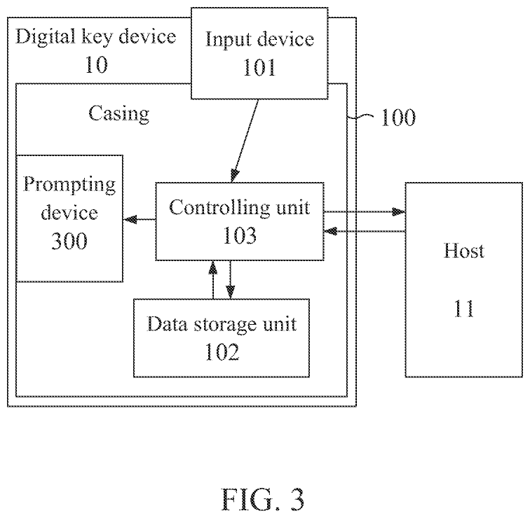

Please refer to FIG. 3, which is a block diagram illustrating a digital key device in communication with a host according to another embodiment of the present disclosure. In the embodiment, the digital key device 10 further includes a prompting device 300 configured to issue a light signal or a sound signal to prompt the user for the input timing of the timing-based input event(s). For example, the prompting device 300 could be a screen or a light emitting diode (LED) indicator (not shown) disposed on the casing 100. If the prompting device 300 is a screen, a prompt for the user operation is shown through the screen wherein the prompt may involve the timing, the designated action, the rhythm, the touch position or the like. If the prompting device 300 is a light emitting diode indicator, the timing of pressing or releasing the button is indicated by flashing light or a change in light color (e.g. in a specific rhythm). Also, the prompting device 300 could be a buzzer or a speaker (not shown) which beeps or gives a voice prompt to indicate the input timing for the timing-based input event(s). The prompting device 300 assists the user to catch the correct timing for the input action(s). It is to be noted that the real form of the prompting device 300 is not limited in the above embodiments. Taking a simplified condition as an example, in the first operation verification procedure, the user performs a single input action through the input device 101 at a specific time point. In an embodiment, following a prompt (e.g. a single light flash) issued by the prompting device 300, the user completes a single touch action, a single sliding action, a single pressing action or a single shaking action relative to the casing 100 or the input device 101 or a single sound-making action at a preset time point to provide the timing-based input event. Alternatively, following a series of prompts, (a series of light flashes) issued by the prompting device 300, the user completes a series of touch actions, a series of sliding actions, a series of pressing actions, a series of shaking actions, a series of sound-making actions or a combination thereof within a preset time period to provide the timing-based input events.

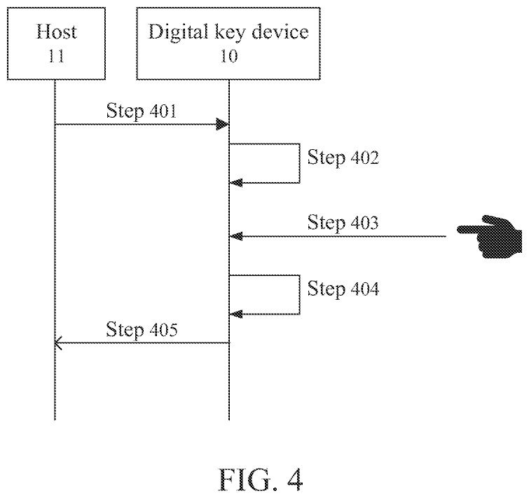

The method with reference to FIG. 2 could be further modified. Please refer to FIG. 4, which is a sequence diagram showing a data reading method according to an embodiment of the present disclosure. After the personal identification number verification procedure and the first operation verification procedure (e.g. gesture operation verification procedure or audio operation verification procedure) performed with the digital key device 10 and the host 11 are passed, a second operation verification procedure (e.g. gesture operation verification procedure or audio operation verification procedure) is introduced and performed by the controlling unit 103. Therefore, the authentication between the digital key device 10 and the host 11 includes the personal identification number verification procedure, the first operation verification procedure and the second operation verification procedure. For example, after the first operation verification procedure is passed, the host 11 sends a data read command together with a designated indexed address to the digital key device 10 (Step 401). The digital key device 10 receives the data read command, and then enters a wait mode (Step 402) to wait for user operation input (Step 403) for the second operation verification procedure. In the second operation verification procedure (Step 404), the digital key device 10 verifies whether the second timing-based input event(s) are correctly provided through the input device 101. If the received second timing-based input event(s) are verified correct, it is determined that the user stays with the digital key device 10 to use the digital key device 10 on-site and the second operation verification procedure is passed. The controlling unit 103 allows the digital data stored in the data storage unit 102 to be automatically transmitted to the host 11 according to the indexed address when both conditions, i.e. receiving the data read command and passing the authentication, are satisfied (Step 405). The digital data could be any type of information data or a user credential. According to the method, the data access to the digital key device 10 (e.g. the host 11 reads the digital data stored in the digital key device 10, or the digital key device 10 sends the user credential to the host 11 for user authentication) is permitted only when the entire authentication is completed and passed. By such verification and authentication mechanism in the data reading method, the data security is enhanced to prevent from malicious access through remote hacking. The second timing-based input set could be identical to the first timing-based input set or not as predetermined by the data owner. Further, the two timing-based operation inputs may adopt the gesture operation input and the audio operation input, respectively.

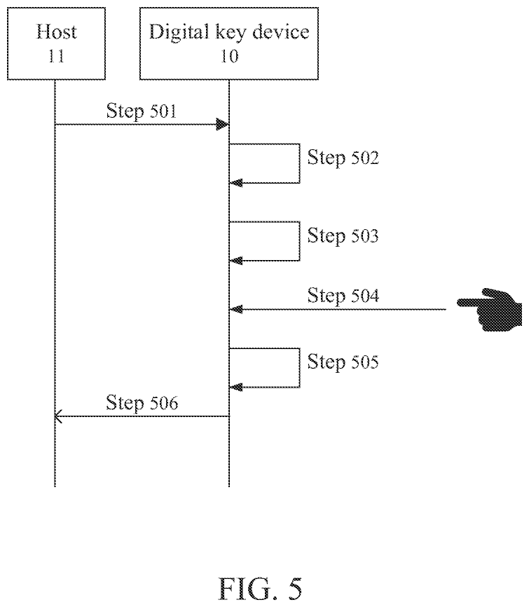

Please refer to FIG. 5, which is a sequence diagram showing a data encryption/decryption method according to an embodiment of the present disclosure. Similarly, the authentication includes a personal identification number verification procedure, a first operation verification procedure (e.g. gesture operation verification procedure or audio operation verification procedure) and a second operation verification procedure (e.g. gesture operation verification procedure or audio operation verification procedure), and all of these procedures are performed by the controlling unit 103. In the data encryption method, after the personal identification number verification procedure and the first operation verification procedure are passed, the host 11 sends a data encrypt command together with plaintext data to be encrypted to the digital key device 10 (Step 501). The data encrypt command may be a digital signing command. The digital key device 10 receives the data encrypt command and the plaintext data, and then uses a digital key stored in the data storage unit 102 to encrypt the plaintext data to generate corresponding encrypted data (ciphertext data) (step 502). Subsequently, the digital key device 10 enters a wait mode (Step 503) to wait for user operation input (e.g. user gesture operation input or user audio operation input) for the second operation verification procedure. After the user inputs the timing-based input event(s) of the second operation input through the input device 101 (Step 504), the digital key device 10 verifies whether the second user operation input as received is correct (Step 505). If the received second operation input is verified correct (i.e. conforming to the second preset timing-based input set), it is determined again that the authorized user stays with the digital key device 10 and the second operation verification procedure is passed. The controlling unit 103 allows the encrypted data to be transmitted to the host 11 in response to the data encrypt command on condition that the authentication is passed (Step 506). The encrypted data could be an encrypted file with and/or without a digital signature. For example, the encrypted file with a digital signature is outputted to the host 11, and the encrypted file without a digital signature is stored in the data storage unit 102 of the digital key device 10. According to the method, the digital key device 10 provides the digital key service using the digital key, and the host 11 can fetch the encrypted data only when the entire authentication is completed and passed. By such verification and authentication mechanism in the data encryption method, the data security is enhanced to prevent from malicious access to the encrypted data through remote hacking when the digital key device 10 is electrically coupled to the host 11. If the digital key device 10 is lost, the access to the encrypted data stored in the lost digital key device 10 without correct user operation input is also denied. Similarly, the second timing-based input set could be identical to the first timing-based input set or not as predetermined by the digital key owner, and the two timing-based input sets may adopt the same type of operation or not.

Please also refer to FIG. 5 for illustration of the data decryption method. After the personal identification number verification procedure and the first gesture operation verification procedure are passed, the host 11 sends a data decrypt command together with encrypted data (ciphertext data) to be decrypted to the digital key device 10 (Step 501). The digital key device 10 receives the data decrypt command and the encrypted data which is previously encrypted by using the digital key stored in the data storage unit 102 or an encrypt key corresponding to the digital key, and then uses the digital key to decrypt the encrypted data to generate corresponding decrypted data (plaintext data) (step 502). Subsequently, the digital key device 10 enters a wait mode (Step 503) to wait for user operation input (e.g. user gesture operation input or user audio operation input) for the second operation verification procedure. After the user inputs the timing-based input event(s) constructing the second operation input through the input device 101 (Step 504), the controlling unit 103 of the digital key device 10 verifies whether the second operation input as received is correct (Step 505). If the received second operation input is verified correct, i.e. conforming to the second preset timing-based input set, it is determined again that the authorized user stays with the digital key device 10 and the second operation verification procedure is passed. The controlling unit 103 allows the decrypted data to be transmitted to the host 11 in response to the data decrypt command on condition that the authentication is passed (Step 506). According to the method, the digital key device 10 provides the digital key service using the digital key, and the host 11 can fetch the decrypted data only when the entire authentication is completed and passed. By such verification and authentication mechanism in the data decryption method, the data security is enhanced to prevent from malicious access to the decrypted data through remote hacking when the digital key device 10 is electrically coupled to the host 11. Similarly, the second timing-based input set could be identical to the first timing-based input set or not as predetermined by the digital key owner, and the two timing-based input sets may adopt the same type of operation or not.

It is to be noted that the digital key service is not limited to the given illustrative embodiments such as data encryption and data decryption. The concepts of the present application can be applied to any digital service requiring a digital key. Such applications are also encompassed in the present application.

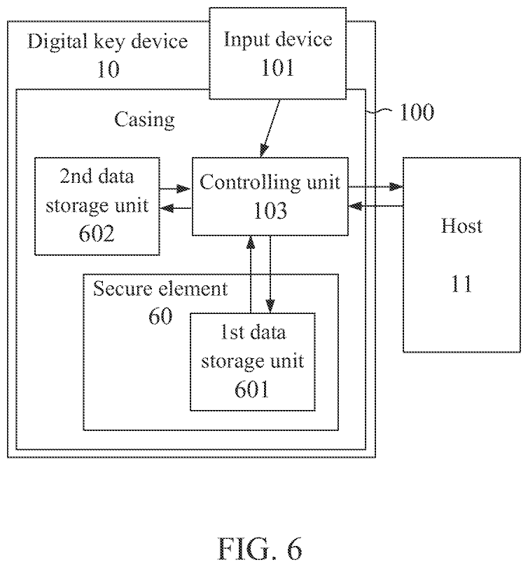

Please refer to FIG. 6, which is a block diagram illustrating a digital key device in communication with a host according to a further embodiment of the present disclosure. The digital key device 10 includes an input device 101 and a controlling unit 103 similar to the digital key device 10 described with reference to FIG. 1. The function and connection relation of similar elements could be obtained by referring to the above embodiments, and detailed description is not given herein. The digital key device 10 further includes a secure element (secure chip or secure cryptoprocessor) 60, and two separate data storage units 601 and 602 are arranged in the digital key device 10. The first data storage unit 601 is disposed in the secure element 60 protected from unauthorized access, and the second data storage unit 602 is disposed outside the secure element 60. The digital key and confidential data are stored in the first data storage unit 601, and non-confidential data are stored in the second data storage unit 602. The secure element 60 may achieve the Common Criteria for Evaluation Assurance Level 5+ (CC EALS+), and the second data storage unit 602 could be a flash memory of a memory card.

According to the present disclosure, access to specific data or all data in the digital key device 10 through the host 11 requires double verification procedure in a two-way manner, including the personal identification number verification procedure and the operation verification procedure. The user operation input provided through the input device 101 of the digital key device 10, not the input device of the host 11 can prevent from undesired and uninvited remote operation. By this authentication mechanism, stealing the data stored in the digital key device 10 through remote hacking (e.g. side-channel attack, brute-force attack, cryptanalysis and exploiting software bug) of the host 11 is avoided. Further, compared to the conventional password, the timing-based input set has higher strength and can not be easily cracked. Through the second operation verification procedure, the digital key service or the digital key provided by the digital key device 10 is kept secure from being stolen or appropriated. It is advantageous that the digital key device 10 with data protection or digital key service function of the present disclosure can be used with the existing hosts or information devices to enhance data storage security.

The relative positions between and the arrangements of the elements, components and/or devices in the above embodiments are not limited to those shown in the drawings, and could be modified or adjusted to meet respective requirements. The steps of respective methods described in the above embodiments teach basic principles, but details of each step are adjustable and modifiable without departing from the given principles. The digital key device of the present disclosure can be applied to various kinds of information devices to enhance the data security and protect the data from impermissible access, especially through remote hacking.

While the disclosure has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

1. A digital key device adapted to be in communication with a host, the digital key device comprising:
a casing;
an input device, disposed near the casing or mounted on the casing, receiving a first user operation input;
a data storage unit, disposed in the casing, storing digital data and a digital key; and
a controlling unit, disposed in the casing and in communication with the host, the input device and the data storage unit, using the digital key stored in the data storage unit to perform a digital key service or outputting the digital data stored in the data storage unit to the host when authentication is complete, wherein the authentication comprises a first operation verification procedure for verifying the first user operation input, and the authentication is complete when the controlling unit determines that the first user operation input conforms to a first preset timing-based input set.

2. The digital key device according to claim 1, wherein the first user operation input is a gesture operation input and the input device is
a touch button, a physical button or a touch pad exposed from the casing, the input device receiving one or more user touch or pressing actions applied to the input device to generate one or more timing-based input events in response to the one or more user touch or pressing actions, or
a vibration sensor disposed in the casing, the vibration sensor sensing vibration or touch made on the casing held by the user to generate the one or more timing-based input events in response to the vibration or touch made on the casing.

3. The digital key device according to claim 1, wherein the first user operation input is an audio operation input and the input device is a microphone disposed on the casing, the microphone sensing a sound made by the user to generate one or more timing-based input events in response to a rhythm of the sound.

4. The digital key device according to claim 1, wherein one or more timing-based input events are generated according to a specific rhythm of the first user operation input and conform to an encoding format.

5. The digital key device according to claim 1, further comprising a prompting device issuing a light signal or a sound signal to prompt the user for input timing of the first user operation input.

6. The digital key device according to claim 1, wherein the authentication further comprises a personal identification number verification procedure prior to the first operation verification procedure after the digital key device is electrically coupled to the host, wherein the digital key device receives a personal identification number from the host and verifies the received personal identification number.

7. The digital key device according to claim 6, wherein the authentication further comprises a second operation verification procedure posterior to the first operation verification procedure; the digital key device activates the second operation verification procedure to verify whether a second user operation input conforms to a second preset timing-based input set after completing the first operation verification procedure and receiving a data read command from the host; and the controlling unit outputs the digital data to the host in response to the data read command after the authentication is passed.

8. The digital key device according to claim 1, wherein the digital key service is using the digital key to encrypt first data received from the host to generate encrypted data with a digital signature, wherein the authentication further comprises a second operation verification procedure posterior to the first operation verification procedure; the digital key device activates the second operation verification procedure to verify whether a second user operation input conforms to a second preset timing-based input set after completing the first operation verification procedure and receiving a digital signing command from the host; and the controlling unit outputs the encrypted data with the digital signature to the host in response to the digital signing command after the authentication is passed.

9. The digital key device according to claim 1, wherein the digital key service is using the digital key to encrypt first data or decrypt second data received from the host to generate first encrypted data or second decrypted data; the authentication further comprises a second operation verification procedure posterior to the first operation verification procedure; the digital key device activates the second operation verification procedure to verify whether a second user operation input conforms to a second preset timing-based input set after completing the first operation verification procedure and receiving a data encrypt command or a data decrypt command from the host; and the controlling unit outputs the first encrypted data or the second decrypted data to the host or stores the first encrypted data or the second decrypted data in the data storage unit in response to the data encrypt command or the data decrypt command after the authentication is passed.

10. The digital key device according to claim 1, wherein the data storage unit includes a first data storage unit and a second data storage unit, wherein the digital key is stored in the first data storage unit disposed in a secure element, and the digital data are stored in the second data storage unit separate from the secure element.

11. A method for activating a digital key service used with a host and a digital key device, the digital key device storing therein digital data and a digital key, the method comprising steps of:
providing a first user operation input to the digital key device; and
the digital key device activating the digital key service using the digital key stored in the digital key device or outputting the digital data to the host automatically when authentication is complete, wherein the authentication comprises a first operation verification procedure for verifying the first user operation input, and the authentication is complete when the first user operation input conforms to a first preset timing-based input set.

12. The method according to claim 11, wherein the first user operation input is a gesture operation input including one or more touch actions, one or more sliding actions, one or more pressing actions, or one or more shaking actions applied to the digital key device and being corresponding to one or more timing-based input events.

13. The method according to claim 11, wherein the first user operation input is an audio operation input including one or more sound-making actions of the user, the one or more sound-making actions following a rhythm and being corresponding to one or more timing-based input events.

14. The method according to claim 11, wherein one or more timing-based input events are generated according to a specific rhythm of the first user operation input and conform to an encoding format.

15. The method according to claim 11, further comprising a step of issuing a light signal or a sound signal through a prompting device of the digital key device to prompt the user for input timing of the first user operation input.

16. The method according to claim 11, wherein the authentication comprises a step of performing a personal identification number verification procedure prior to the first operation verification procedure after the digital key device is electrically coupled to the host.

17. The method according to claim 11, wherein the authentication comprises a second operation verification procedure posterior to the first operation verification procedure, the method comprising steps of:
activating the second operation verification procedure to verify whether a second user operation input conforms to a second preset timing-based input set after completing the first operation verification procedure and receiving a data read command from the host; and
outputting the digital data stored in the digital key device to the host in response to the data read command after the authentication is passed.

18. The method according to claim 11, wherein the digital key service is using the digital key to encrypt first data received from the host to generate encrypted data with a digital signature, and the authentication further comprises a second operation verification procedure posterior to the first operation verification procedure, the method comprising steps of:
activating the second operation verification procedure to verify whether a second user operation input conforms to a second preset timing-based input set after completing the first operation verification procedure and receiving a digital signing command from the host; and
outputting the encrypted data with the digital signature to the host in response to the digital signing command after the authentication is passed.

19. The method according to claim 11, wherein the digital key service is using the digital key to encrypt first data or decrypt second data received from the host to generate first encrypted data or second decrypted data, and the authentication further comprises a second operation verification procedure posterior to the first operation verification procedure, the method comprising steps of:
activating the second operation verification procedure to verify whether a second user operation input conforms to a second preset timing-based input set after completing the first operation verification procedure and receiving a data encrypt command or a data decrypt command from the host; and
outputting the first encrypted data or the second decrypted data to the host or storing the first encrypted data or the second decrypted data in the data storage unit in response to the data encrypt command or the data decrypt command after the authentication is passed.
